(19) United States
(12) Patent Application Publication
(10) Pub. No.: US 2022/0073799 A1
(43) Pub. Date: Mar. 10, 2022

(54) COMPOSITION MADE FROM EPOXY RESIN AND POLYURETHANE

(71) Applicant: BOSTIK SA, Colombes (FR)

(72) Inventors: Guillaume MICHAUD, Venette (FR); Marjorie PEREIRA-BAYART, Venette (FR)

(21) Appl. No.: 17/415,770

(22) PCT Filed: Dec. 18, 2019
(86) PCT No.: PCT/FR2019/053150

§ 371 Date: Jun. 18, 2021

(30) Foreign Application Priority Data
Dec. 20, 2018 (FR) 1873461

(51) Int. Cl. C09J 175/16; C09J 5/00

(52) U.S. Cl. CPC C09J 175/16; C09J 2463/00; C09J 2475/00; C09J 5/00

(57) ABSTRACT

The present invention relates to a composition comprising:
a composition A comprising:
   at least one polyurethane P comprising at least two acrylate end functions; and
   at least one epoxy resin;
and
a composition B comprising:
   at least one polyamine B1 comprising at least two functions chosen from primary and secondary amines;
   at least one polyamine B2, different than the polyamine B1, comprising at least two functions chosen from primary and secondary amines;
said composition being characterized in that:
   it does not comprise any polythiol; and
   the weight ratio of polyurethane(s) P/epoxy resin(s) in the composition A ranges from 1/49 to 99/1.

### FIELD OF THE INVENTION

The present invention relates to a composition based on polyurethane and on epoxy resin.

The invention also relates to the use of said composition in the repair and/or the semi-structural or structural adhesive bonding of materials in the transportation, marine or construction field.

### TECHNOLOGICAL BACKGROUND

The choice of adhesives is determined by the applications thereof and the processes for the preparation thereof. Adhesives in the transportation field, such as the motor vehicle field, are categorized as structural adhesives or elastic adhesives. Structural adhesives are high-modulus adhesives, whereas elastic adhesives are low-modulus adhesives.

Typically, compositions based on epoxy and/or on polyurethane are used for structural adhesive bonding in the motor vehicle field.

Epoxy-based compositions generally result in adhesives which have little elongation, and which therefore prove to be brittle and fragile.

Polyurethane-based adhesive compositions generally have the drawback of using an —NCO component comprising high residual contents of diisocyanate monomers originating from the reaction for the synthesis of the polyurethane prepolymer bearing NCO groups (or bearing NCO end groups). This is because these residual diisocyanate monomers are capable of resulting in a number of undesirable effects.

The presence of high contents of residual monomers is dangerous for the handling and the health of the users, which implies restrictions of use and the implementation of ventilation systems. The installation of these systems is not always possible, for example in the context of the adhesive bonding or repair of motor vehicle parts (garage employees) or in construction. Moreover, in order to take into account the undesirable effects related to the presence of these diisocyanate monomers, regulations require, for some types of products, a specific labelling of the product, if the concentration of aromatic diisocyanate monomers exceeds 0.1% by weight of the weight of the product and/or if the concentration of aliphatic diisocyanate monomers exceeds 0.5% by weight of the weight of the product, indeed even 0.1% by weight of the weight of the product.

There is in particular a need to provide new compositions for semi-structural or structural adhesive bondings, which have a low residual monomer content, and/or which result in adhesives that exhibit a good tensile strength/elongation at break compromise.

### DESCRIPTION OF THE INVENTION

In the present patent application, unless otherwise indicated:
the amounts expressed in the percentage form correspond to weight/weight percentages;
the hydroxyl number of an alcoholic compound represents the number of hydroxyl functions per gram of product, and is expressed in the form of the equivalent number of milligrams of potassium hydroxide (KOH) used in the assay of the hydroxyl functions, per gram of product;
the primary alkalinity represents the number of —NH₂ functions per gram of product, and is expressed in the form of the number of milliequivalents of —NH₂ per gram of product. It may be measured by NMR or by potentiometry according to methods that are well known to those skilled in the art;
the secondary alkalinity represents the number of —NH— functions per gram of product, and is expressed in the form of the number of milliequivalents of —NH— per gram of product. It may be measured by NMR or by potentiometry according to methods that are well known to those skilled in the art;
the total alkalinity represents the number of amino functions (of primary, secondary and tertiary amine type) per gram of product, and is expressed in the form of milliequivalents of HCl per gram of product. The total alkalinity may be determined by NMR or by potentiometric assay;
the viscosity measurement at 23° C. (or at 25° C.) may be performed using a Brookfield viscometer according to the standard ISO 2555. Typically, the measurement taken at 23° C. (or at 25° C.) may be performed using a Brookfield RVT viscometer with a spindle suitable for the viscosity range and at a rotational speed of 20 revolutions per minute (rpm). The viscosity of a product is preferably measured at least 24 hours after manufacture of said product;
the number-average molecular weights (Mn) of the polyols, expressed in g/mol, are calculated from their hydroxyl numbers and from their functionalities;
the molar masses of the polyamines (B1), expressed in g/mol, are calculated from their primary and/or total alkalinities, and from their functionality;
the molar masses (or average molar masses in the case of a mixture) of the polyamines (B2) are calculated from their chemical structures (¹H/¹³C NMR) and from their primary and/or secondary and/or tertiary and/or total alkalinities.

### A. Composition

The present invention relates to a composition, preferably an adhesive composition, comprising:
a composition A comprising:
   at least one polyurethane P comprising at least two acrylate end functions; and
   at least one epoxy resin;
and
a composition B comprising:
   at least one polyamine B1 comprising at least two functions chosen from primary and secondary amines;
   at least one polyamine B2, different than the polyamine B1, comprising at least two functions chosen from primary and secondary amines;
said composition being characterized in that:
   it does not comprise any polythiol; and
   the weight ratio of polyurethane(s) P/epoxy resin(s) in the composition A ranges from 51/49 to 99/1.

A.1. Composition A

### Epoxy Resin

The epoxy resin may be aliphatic, cycloaliphatic, heterocyclic or aromatic.

The epoxy resin may be monomeric or polymeric.

Preferably, the epoxy resin has a viscosity, measured at 25° C., ranging from 7 to 13 000 mPa·s, preferentially from 400 to 5000 mPa·s.

According to one embodiment, the epoxy resins are chosen from polyglycidyl ethers of polyphenolic compounds, preferably comprising from 2 to 6 glycidyl ether functions per mole of resin.

A phenolic compound is a compound having at least two aromatic hydroxyl groups.

The phenolic compounds can be chosen from the group consisting of resorcinol, catechol, hydroquinone, bisphenol A (2,2-bis-(4-hydroxyphenyl)propane), bisphenol AP (1,1-bis(4-hydroxyphenyl)-1-phenylethane), bisphenol AF (2,2-bis-(4-hydroxyphenyl)hexafluoropropane), bisphenol B ((2,2-bis(4-hydroxyphenyl)butane), bisphenol BP (bis(4-hydroxyphenyl)diphenylmethane), bisphenol C (2,2-bis(3-methyl-4-hydroxyphenyl)propane), bisphenol CII (bis(4-hydroxyphenyl)-2,2-dichloroethylene), bisphenol E (1,1-bis(4-hydroxyphenyl)ethane), bisphenol F (bis(4-hydroxyphenyl)-2,2-dichloroethylene), bisphenol FL (4,4′-(9H-fluoren-9-ylidene)bisphenol, bisphenol G (2,2-bis(4-hydroxy-3-isopropylphenyl)propane), bisphenol M (1,3-bis(2-(4-hydroxyphenyl)-2-propyl)benzene), bisphenol P (1,4-bis(2-4-hydroxyphenyl)-2-propyl)benzene), bisphenol PH (5,5′-(1-methylethylidene)-bis[1,1′-(bisphenyl)-2ol]propane), bisphenol S (bis(4-hydroxyphenyl)sulfone), bisphenol TMC (1,1-bis(4-hydroxyphenyl)-3,3,5-trimethylcyclohexane); bisphenol Z (1,1-bis(4-hydroxyphenyl)cyclohexane), bisphenol K, tetraethylbiphenol, and mixtures thereof.

The epoxy resin can have an epoxy function content ranging from 0.3 to 10.8 meq per gram of resin.

The epoxy functionality of the epoxy resin can range from 2 to 6.

The epoxy functionality of the epoxy resin is the mean number of epoxy functions per mole of epoxy resin.

The resins can be chosen from the following resins:

the resins having formula (I) below:

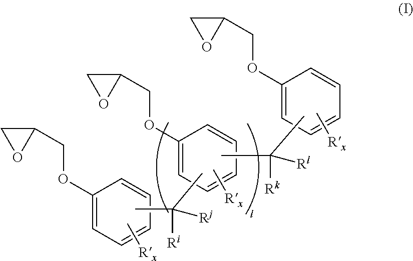

wherein:
I represents a number ranging from 0 to 8, preferably from 0 to 4;
each R′ represents, independently of one another, an alkyl radical comprising from 1 to 20 carbon atoms, preferably a methyl;
each of Rⁱ, R^{j}, R^{k} and R^{l}, independently of one another, represents one of the following radicals: H; a linear or branched, cyclic or aliphatic alkyl radical comprising from 1 to 10 carbon atoms; an aryl radical comprising from 6 to 12 carbon atoms; or a radical —CF₃;
each x represents an integer ranging from 0 to 4, x preferably being 0 or 1; -N,N-diglycidyl-4-glycidyloxyaniline (TGAP):

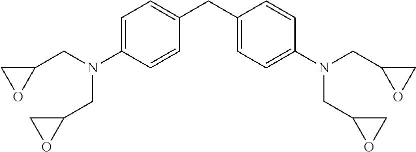 [SMILES: c1cc(N(CC2CO2)CC2CO2)ccc1Cc1ccc(N(CC2CO2)CC2CO2)cc1]

the resins of formula (II) below:

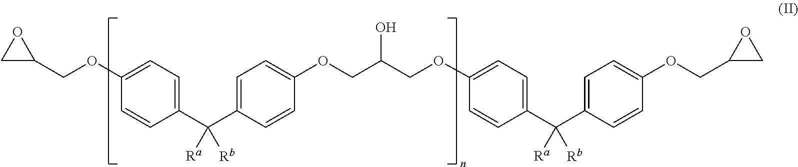

wherein:
n is an integer ranging from 1 to 25, preferably from 1 to 5;
each of R^{a} and R^{b} is, independently of one another, one of the following radicals: H; a linear or branched, cyclic or aliphatic alkyl radical comprising from 1 to 10 carbon atoms; an aryl radical comprising from 6 to 12 carbon atoms; or a radical —CF₃;

and mixtures thereof.

The term “mixture” is intended to mean a mixture of several resins mentioned above. It may for example be a mixture of different resins of formula (I), or else a mixture of a resin of formula (I) with a resin of formula (II), or else any other possible mixture.

Preferably, among the resins of formula (I), mention may for example be made of the following resins:

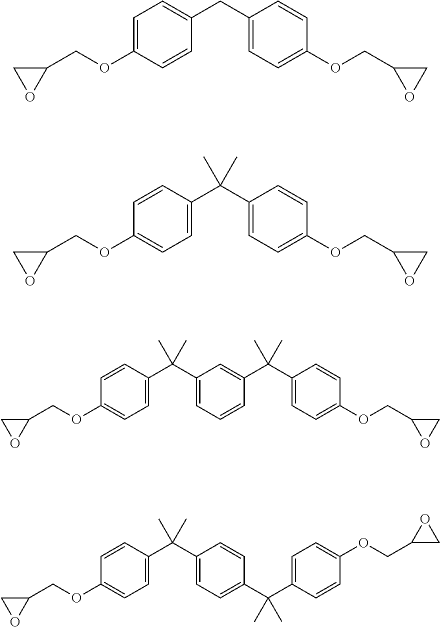 [SMILES: c1cc(OCC2CO2)ccc1Cc1ccc(OCC2CO2)cc1 ; CC(C)(c1ccc(OCC2CO2)cc1)c1ccc(OCC2CO2)cc1 ; CC(C)(c1ccc(OCC2CO2)cc1)c1cccc(C(C)(C)c2ccc(OCC3CO3)cc2)c1 ; CC(C)(c1ccc(OCC2CO2)cc1)c1ccc(C(C)(C)c2ccc(OCC3CO3)cc2)cc1]

The abovementioned resins of formula (II) are preferably those wherein R^{a} and R^{b} represent, independently of one another, H or a methyl.

According to one preferred embodiment, the composition A comprises at least one epoxy resin of formula (I) mentioned above, and in particular of formula (I-1) mentioned above.

Numerous epoxy resins are typically commercially available. Mention may for example be made of the D.E.R.™ 331 and D.E.R.™ 383 resins sold by Dow Chemicals, the Epon 862 resin sold by Hexion Speciality Chemicals, the Eposir® resins based on bisphenol A sold by SIR Industrial (for example Eposir® 7120), and the Eposir® resins based on bisphenol A/bisphenol F (for example Eposir® F556).

### Polyurethane P

The polyurethane P according to the invention comprises at least two acrylate end functions.

The acrylate end functions of the polyurethane P have formula (III) below:

CH₂═CH—C(═O)− (III)

The polyurethane P according to the invention can have an acrylate function content ranging from 0.2 to 3 meq per gram of polyurethane P, preferably from 0.5 to 2 meq per gram of polyurethane P, preferentially from 0.90 to 1.3 meq per gram of polyurethane P, and advantageously from 0.90 to 1.2 meq per gram of polyurethane P.

The acrylate functionality of the polyurethane P can range from 1 to 4, preferably from 2 to 3.

The acrylate functionality is the mean number of acrylate functions per mole of polyurethane P.

The abovementioned polyurethane P can have a number-average molecular weight (Mn) ranging from 1000 to 50000, preferably from 2000 to 20000 and preferentially from 3000 to 15000 g/mol.

The viscosity of the polyurethane P, measured at 23° C., can range from 1 to 200000 mPa·s, preferably from 1 to 185000 mPa·s.

The abovementioned polyurethane P can be obtained by reaction:
i) of a polyurethane comprising at least two —OH end functions and of at least one compound chosen from acrylic acid chloride or an acrylic acid ester; or
ii) of a polyurethane comprising at least two —OH end functions and of at least one compound chosen from an isocyanatoalkyl acrylate;
or
iii) of a polyurethane comprising at least two —NCO end functions and of at least one compound chosen from a hydroxylated ester of acrylic acid.

Case i)

According to a first embodiment, the abovementioned polyurethane P is prepared by reacting a polyurethane comprising at least two —OH end functions; and at least one acrylic acid chloride or at least one acrylic acid ester.

In particular, the abovementioned polyurethane P is prepared according to a process comprising the following steps:

E1) the preparation of a polyurethane bearing OH end groups via a polyaddition reaction:
i) of at least one polyisocyanate, preferably chosen from diisocyanates, triisocyanates, and mixtures thereof;
ii) with at least one polyol, preferably chosen from polyester polyols, polyether polyols, poly(ether-ester) polyols, polyene polyols, polycarbonate polyols, poly(ether-carbonate) polyols, polycaprolactone polyols, and mixtures thereof;
   in amounts such that the NCO/OH mole ratio (r1) is strictly less than 1, preferably ranges from 0.2 to 0.8 and preferentially ranges from 0.3 to 0.5;

and

E2) the reaction of the product formed on conclusion of step E1) with the acrylic acid chloride or with an acrylic acid ester, in amounts such that the OH/—C(═O)X′ mole ratio (with X′ representing Cl or O) (r2) is less than or equal to 1, preferably ranges from 0.90 to 1.00 and preferentially ranges from 0.95 to 1.00.

In the context of the invention, and unless otherwise mentioned, (r1) is the NCO/OH mole ratio corresponding to the mole ratio of the number of isocyanate (NCO) groups to the number of hydroxyl (OH) groups carried by all of the polyisocyanate(s) and polyol(s) present in the reaction medium of step E1).

In the context of the invention, and unless otherwise mentioned, (r2) is the OH/—C(═O)X′ mole ratio (with X′ representing Cl or O) corresponding to the mole ratio of the number of hydroxyl groups (OH) to the number of —C(═O)—Cl (acid chloride) groups or —C(═O)—O (ester) groups borne, respectively, by all of the alcohol compounds (polyurethane bearing —OH end groups obtained on conclusion of step E1) and optionally the polyol(s) which have not reacted on conclusion of step E1)), and acrylic derivatives (acrylic acid chloride or acrylic acid ester present in the reaction medium of step E2).

The polyisocyanates and polyols are as described hereinafter.

Case ii)

According to a second embodiment, the polyurethane P according to the invention is prepared by reacting a polyurethane comprising at least two —OH end functions, and at least one compound chosen from isocyanatoalkyl acrylates.

The term “isocyanatoalkyl acrylate” is intended to mean a compound having the following formula:

CH₂═CH—C(═O)—O—R^{s}—NCO

wherein R^{s} represents a linear or branched alkylene radical comprising from 1 to 20 carbon atoms, preferably from 1 to 10 carbon atoms.

In particular, the abovementioned polyurethane P is prepared according to a process comprising the following steps:

E′1) the preparation of a polyurethane bearing OH end groups via a polyaddition reaction:
i) of at least one polyisocyanate, preferably chosen from diisocyanates, triisocyanates, and mixtures thereof;
ii) with at least one polyol, preferably chosen from polyester polyols, polyether polyols, poly(ether-ester) polyols, polyene polyols, polycarbonate polyols, poly(ether-carbonate) polyols, polycaprolactone polyols, and mixtures thereof;
   in amounts such that the NCO/OH mole ratio (r3) is strictly less than 1, preferably ranges from 0.2 to 0.8 and preferentially ranges from 0.3 to 0.5;

and

E′2) the reaction of the product formed at the end of step E′1) with at least one isocyanatoalkyl acrylate, in amounts such that the OH/NCO mole ratio (r4) is less than or equal to 1, preferably ranges from 0.90 to 1.00 and preferentially ranges from 0.95 to 1.00.

In the context of the invention, and unless otherwise mentioned, (r3) is the NCO/OH mole ratio corresponding to the mole ratio of the number of isocyanate groups (NCO) to the number of hydroxyl groups (OH) borne by all of the polyisocyanate(s) and polyol(s) present in the reaction medium of step E′1).

In the context of the invention, and unless otherwise mentioned, (r4) is the OH/NCO mole ratio corresponding to the mole ratio of the number of hydroxyl (OH) groups to the number of isocyanate (NCO) groups borne by all of the polyol(s) (polyurethane bearing OH end groups, obtained at the end of step E′1, and optionally residual polyol(s)) and polyisocyanate(s) (isocyanatoalkyl acrylate(s) and optionally residual polyisocyanate(s) of the step E′1) present in the reaction medium of step E′2).

The polyisocyanates and polyols are as described hereinafter.

Case iii)

According to a third embodiment, the abovementioned polyurethane P is prepared by reacting a polyurethane comprising at least two —NCO end functions, and at least one hydroxylated ester of acrylic acid.

In the context of the invention, and unless otherwise mentioned, the term “hydroxylated ester of acrylic acid” means an acrylic acid ester wherein the ester radical is substituted with at least one hydroxyl group. A hydroxylated ester of acrylic acid may be represented, for example, by the following formula:

CH₂═CH—C(═O)—O—R

wherein R represents an organic radical substituted with at least one hydroxyl group.

According to one embodiment, the hydroxylated ester of acrylic acid has formula (IV) below:

CH₂═CH—C(═O)—O—R⁰—OH (IV)

wherein R⁰ represents a linear or branched, aliphatic or cyclic, saturated or unsaturated divalent hydrocarbon-based radical, preferably comprising from 2 to 240 carbon atoms and being optionally interrupted with one or more heteroatoms (for instance O, S, and in particular O), and/or optionally interrupted with one or more aromatic groups, and/or optionally interrupted with one or more divalent groups —N(R_{c})— with R_{c} representing a linear or branched alkyl radical comprising from 1 to 22 carbon atoms (tertiary amine), —C(═O)O— (ester), —C(═O)NH— (amide), —NHC(═O)O— (carbamate), —NHC(═O)—NH— (urea), or —C(═O)— (carbonyl), and/or being optionally substituted.

Preferably, the hydroxylated ester of acrylic acid has one of the following formulae:

CH₂═CH—C(═O)—O—R¹—OH Formula (IV-1):

wherein R¹ represents a linear or branched, aliphatic or cyclic, saturated or unsaturated divalent alkylene radical, comprising from 2 to 22 carbon atoms, preferably from 2 to 18, preferentially from 2 to 14, even more preferentially from 2 to 10 and advantageously from 2 to 6 carbon atoms;

CH₂═CH—C(═O)—O—R²—O—[C(═O)—(CH₂)ᵣ—O]ₛ—H Formula (IV-2):

wherein:
r is an integer ranging from 1 to 10, preferably from 1 to 5, and preferentially r is equal to 5;
s is an integer ranging from 1 to 10, s preferably being equal to 2;
R² represents a linear or branched, aliphatic or cyclic, saturated or unsaturated divalent alkylene radical, comprising from 2 to 22 carbon atoms, preferably from 2 to 18, preferentially from 2 to 14, even more preferentially from 2 to 10 and advantageously from 2 to 6 carbon atoms;

CH₂═CH—C(═O)—O—[R³—O]ᵣ—H Formula (IV-3):

wherein R³ represents a linear or branched, aliphatic or cyclic, saturated or unsaturated divalent alkylene radical, comprising from 2 to 4 carbon atoms, t is an integer ranging from 2 to 120, preferably from 1 to 10, t preferably being equal to 2 or 3.

Among the hydroxylated esters of acrylic acid of formula (II-1), examples that may be mentioned include 2-hydroxyethyl acrylate (HEA), 2-hydroxypropyl acrylate (HPA), 4-hydroxybutyl acrylate (4-HBA) and 2-hydroxybutyl acrylate (HBA) (which are available, for example, from Sartomer, Cognis or BASF).

Among the compounds of formula (II-2) above, examples that may be mentioned include polycaprolactone acrylate SR 495B (CAPA) available from Sartomer or hydroxyethylcaprolactone acrylate (HECLA) available from BASF.

Among the ethoxylated and/or propoxylated derivatives of acrylic acid of the abovementioned formula (II-3), examples that may be mentioned include Blemmer® AP-150, Blemmer® AP-200, Blemmer® AP-400, Blemmer® AP-550, Blemmer® AP-800, Blemmer® AP-1000, Blemmer® AE-90, Blemmer® AE-150, Blemmer® AE-200, Blemmer® AE-350 and Blemmer® AE-400, sold by Nippon Oil & Fats Corporation, or SR 604 from Sartomer.

Preferably, the hydroxylated ester of acrylic acid has the abovementioned formula (IV-1), and in particular one of formulae (IV-1-1) and (IV-1-2) below:

CH₂═CH—C(═O)—O—CH₂—CH₂—OH formula (IV-1-1): 2-hydroxyethyl acrylate (HEA):

CH₂═CH—C(═O)—O—CH₂—CH(Me)-OH formula (IV-1-2): 2-hydroxypropyl acrylate (HPA)

Preferably, the abovementioned polyurethane P is prepared via a process comprising the following steps:

E″1) the preparation of a polyurethane bearing NCO end groups via a polyaddition reaction:
i) of at least one polyisocyanate, preferably chosen from diisocyanates, triisocyanates, and mixtures thereof;
ii) with at least one polyol, preferably chosen from polyester polyols, polyether polyols, poly(ether-ester) polyols, polyene polyols, polycarbonate polyols, poly(ether-carbonate) polyols, polycaprolactone polyols, and mixtures thereof;
   in amounts such that the NCO/OH mole ratio (r5) is strictly greater than 1, preferably ranges from 1.3 to 2.0 and preferentially ranges from 1.5 to 1.7;

and

E″2) the reaction of the product formed on conclusion of step E1) with at least one hydroxylated ester of acrylic acid as defined above, in amounts such that the OH/NCO mole ratio (r6) is less than or equal to 1, preferably ranges from 0.90 to 1.00 and preferentially ranges from 0.95 to 1.00.

Preferentially, step E″2) is performed with at least one hydroxylated ester of acrylic acid as defined above, preferably of the abovementioned formulae (IV-1-1) or (IV-1-2).

In the context of the invention, and unless otherwise mentioned, (r5) is the NCO/OH mole ratio corresponding to the mole ratio of the number of isocyanate groups (NCO) to the number of hydroxyl groups (OH) borne by all of the polyisocyanate(s) and polyol(s) present in the reaction medium of step E″1).

When the polyurethane carrying NCO end groups is obtained during step E″1) from a mixture of polyisocyanates or from several polyisocyanates added successively, the calculation of the mole ratio (r5) takes into account, on the one hand, the NCO groups carried by all of the polyisocyanate(s) present in the reaction medium of step E″1) and, on the other hand, the OH groups carried by the polyol(s) present in the reaction medium of step E″1).

In the context of the invention, and unless otherwise mentioned, (r6) is the OH/NCO mole ratio corresponding to the mole ratio of the number of hydroxyl (OH) groups to the number of isocyanate (NCO) groups carried respectively by all of the alcohol(s) and of the isocyanate(s) (as regards in particular the polyurethane having NCO end groups and optionally the polyisocyanate(s) which have not reacted on conclusion of step E″1)) present in the reaction medium of step E″2).

The polyurethane comprising at least two —NCO end functions, obtained in step E″1) can have from 1 to 1.8 milliequivalents per gram of NCO functions per gram of said polyurethane, more preferentially from 1 to 1.5 milliequivalents per gram of NCO functions per gram of said polyurethane.

The polyurethane comprising at least two —NCO end functions, obtained in step E″1) can have an NCO group content ranging from 4% to 7% by weight, preferably from 4.4% to 6.3% by weight relative to the total weight of said polyurethane.

Preferably, the NCO functionality of the polyurethane comprising at least two —NCO end functions ranges from 2 to 3.

The NCO functionality of the polyurethane comprising at least two NCO end functions is the average number of NCO functions per mole of polyurethane.

Steps E1), E′1) and E″1)

Polyol(s)

The polyols below can also be used in step E1), E′1) or E″1) as defined above.

The polyol(s) used according to the invention may be chosen from those having a number-average molecular weight (Mn) that ranges from 200 to 20000 g/mol, preferably from 300 to 12000 g/mol and preferentially from 400 to 4000 g/mol.

Preferably, their hydroxyl functionality ranges from 2 to 6, preferentially from 2 to 3. The hydroxyl functionality is the mean number of hydroxyl functions per mole of polyol.

Preferably, the polyol(s) that may be used according to the invention have an (average) hydroxyl number (OHN) ranging from 5 to 840 milligrams of KOH per gram of polyol (mg KOH/g), preferably from 9 to 560 mg KOH/g, preferably from 28 to 420 mg KOH/g, more preferably from 100 to 400 mg KOH/g.

According to a particular embodiment, the hydroxyl number of polyol(s) having a hydroxyl functionality of 2 ranges from 5 to 560 mg KOH/g, preferably from 9 to 374 mg KOH/g, preferably from 28 to 280 mg KOH/g, more preferably from 100 to 280 mg KOH/g.

According to one embodiment, the hydroxyl number of polyol(s) having a hydroxyl functionality of 3 ranges from 8 to 840 mg KOH/g, preferably 14 to 560 mg KOH/g, preferably from 42 to 420 mg KOH/g, more preferably from 200 to 400 mg KOH/g.

The polyol(s) that can be used may be chosen from polyester polyols, polyether polyols, poly(ether-ester) polyols, polyene polyols, polycarbonate polyols, poly(ether-carbonate) polyols, polycaprolactone polyols, poly(meth)acrylate polyols, and mixtures thereof.

The polyol(s) that can be used can be chosen from aromatic polyols, aliphatic polyols, arylaliphatic polyols and the mixtures of these compounds.

According to the invention, the polyester polyol(s) may have a number-average molecular weight ranging from 1000 g/mol to 10000 g/mol, preferably from 1000 g/mol to 6000 g/mol.

The polyester polyols may be chosen from polyester diols and polyester triols, and preferably from polyester diols.

Among the polyester polyols, examples that may be mentioned include:

polyester polyols of natural origin, such as castor oil;

polyester polyols resulting from the polycondensation:
of one or more aliphatic (linear, branched or cyclic) or aromatic polyols, such as, for example, monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer and mixtures thereof, with
one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer and the mixtures of these acids, an unsaturated anhydride, such as, for example, maleic or phthalic anhydride, or a lactone, such as, for example, caprolactone;

estolide polyols resulting from the polycondensation of one or more hydroxy acids, such as ricinoleic acid, with a diol (examples that may be mentioned include Polycin® D-1000 and Polycin® D-2000 available from Vertellus).

The abovementioned polyester polyols can be prepared conventionally and are for the most part commercially available.

Mention may be made, among polyester polyols, for example, of the following products with a hydroxyl functionality equal to 2:
Tone® 0240 (sold by Union Carbide), which is a polycaprolactone with a number-average molecular weight of approximately 2000 g/mol and a melting point of approximately 50° C.,
Dynacoll® 7381 (sold by Evonik) with a number-average molecular weight of approximately 3500 g/mol and having a melting point of approximately 65° C.,
Dynacoll® 7360 (sold by Evonik), which results from the condensation of adipic acid with hexanediol and has a number-average molecular weight of approximately 3500 g/mol and a melting point of approximately 55° C.,
Dynacoll® 7330 (sold by Evonik) with a number-average molecular weight of approximately 3500 g/mol and having a melting point of approximately 85° C.,
Dynacoll® 7363 (sold by Evonik), which also results from the condensation of adipic acid with hexanediol and has a number-average molecular weight of approximately 5500 g/mol and a melting point of approximately 57° C.,
Dynacoll® 7250 (sold by Evonik): polyester polyol having a viscosity of 180 Pa·s at 23° C., a number-average molecular weight Mn equal to 5500 g/mol and a T_{g} equal to −50° C.,
Kuraray® P-6010 (sold by Kuraray): polyester polyol having a viscosity of 68 Pa·s at 23° C., a number-average molecular weight Mn equal to 6000 g/mol and a T_{g} equal to −64° C.,
Kuraray® P-10010 (sold by Kuraray): polyester polyol having a viscosity of 687 Pa·s at 23° C. and a number-average molecular weight Mn equal to 10000 g/mol,
Realkyd® XTR 10410 (sold by Cray Valley): polyester polyol with a number-average molecular weight Mn in the region of 1000 g/mol and the hydroxyl number of which ranges from 108 to 116 mg KOH/g. It is a product resulting from the condensation of adipic acid, diethylene glycol and monoethylene glycol,
Dekatol®3008 (sold by Bostik) with a number-average molar mass Mn in the region of 1060 g/mol and the hydroxyl number of which ranges from 102 to 112 mg KOH/g. It is a product resulting from the condensation of adipic acid, diethylene glycol and monoethylene glycol.

According to the invention, the polyether polyol(s) may have a number-average molecular weight ranging from 200 to 20000 g/mol, preferably from 300 to 12000 g/mol and preferentially from 400 to 4000 g/mol.

The polyether polyol(s) that may be used according to the invention is (are) preferably chosen from polyoxyalkylene polyols, the linear or branched alkylene portion of which comprises from 1 to 4 carbon atoms, more preferentially from 2 to 3 carbon atoms.

More preferentially, the polyether polyol(s) that may be used according to the invention is (are) preferably chosen from polyoxyalkylene diols or polyoxyalkylene triols, the linear or branched alkylene portion of which comprises from 1 to 4 carbon atoms, more preferentially from 2 to 3 carbon atoms.

As examples of polyoxyalkylene diols or triols that may be used according to the invention, mention may be made of:

polyoxypropylene diols or triols (also denoted by polypropylene glycol (PPG) diols or triols) having a number-average molecular weight (Mn) ranging from 300 to 20000 g/mol;

polyoxyethylene diols or triols (also denoted by polyethylene glycol (PEG) diols or triols) having a number-average molecular weight (Mn) ranging from 300 to 20000 g/mol;

and mixtures thereof.

The abovementioned polyether polyols may be prepared conventionally and are widely available commercially. They can be obtained by polymerization of the corresponding alkylene oxide in the presence of a basic catalyst (for example potassium hydroxide) or of a catalyst based on a double metal/cyanide complex.

As examples of polyether diols, mention may be made of the polyoxypropylene diol sold under the name Voranol® P 400 by Dow, with a number-average molecular weight (Mn) in the region of 400 g/mol and the hydroxyl number of which ranges from 250 to 270 mg KOH/g.

As examples of polyether triols, mention may be made of the polyoxypropylene triol sold under the name Voranol® CP 450 by Dow, with a number-average molecular weight (Mn) in the region of 450 g/mol and the hydroxyl number of which ranges from 370 to 396 mg KOH/g, or the polyoxypropylene triol sold under the name Voranol® CP3355 by Dow, with a number-average molecular weight in the region of 3554 g/mol.

The polyene polyol(s) that can be used according to the invention can be chosen preferably from polyenes comprising hydroxyl end groups, and the corresponding hydrogenated or epoxidized derivatives thereof, having in particular a number-average molecular weight (Mn) ranging from 1000 to 10000 g/mol, preferentially from 1000 to 5000 g/mol.

Preferably, the polyene polyol(s) that may be used according to the invention is (are) chosen from polybutadienes or polyisoprenes comprising hydroxyl end groups, which are optionally hydrogenated or epoxidized. Preferentially, the polyene polyol(s) that can be used according to the invention is (are) chosen from butadiene and/or isoprene homopolymers and copolymers comprising hydroxyl end groups, which are optionally hydrogenated or epoxidized.

In the context of the invention, and unless otherwise mentioned, the term “hydroxyl end groups” of a polyene polyol is understood to mean the hydroxyl groups located at the ends of the main chain of the polyene polyol.

The abovementioned hydrogenated derivatives can be obtained by complete or partial hydrogenation of the double bonds of a polydiene comprising hydroxyl end groups, and are thus saturated or unsaturated.

The abovementioned epoxidized derivatives can be obtained by chemoselective epoxidation of the double bonds of the main chain of a polyene comprising hydroxyl end groups, and thus comprise at least one epoxy group in their main chain.

Mention may be made, as examples of polyene polyols, of:

saturated or unsaturated butadiene homopolymer diols comprising hydroxyl end groups, such as those sold under the name Poly BD@ R45HT (Mn=2800 g/mol) or Krasol® (Mn=2400 to 3100 g/mol) by Cray Valley or else Poly BD@ R15HT (Mn=1200 g/mol) sold by Idemitsu Kosan;

saturated or unsaturated isoprene homopolymer diols comprising hydroxyl end groups, such as, for example, those sold under the name Poly IP™ (unsaturated, Mn=2000 g/mol) or EpoI™ (saturated, Mn=2600 g/mol) by Idemitsu Kosan.

The polycarbonate polyols may be chosen from polycarbonate diols or triols, in particular with a number-average molecular weight (Mₙ) ranging from 300 to 12000 g/mol.

Examples of polycarbonate diols that may be mentioned include:

Converge® Polyol 212-10 and Converge@ Polyol 212-20 sold by Novomer, with respective number-average molecular weights (Mo) equal to 1000 and 2000 g/mol, the hydroxyl numbers of which are, respectively, 112 and 56 mg KOH/g,

Desmophen® C XP 2716 sold by Covestro, with a number-average molecular weight (Mₙ) equal to 326 g/mol, and the hydroxyl number of which is 344 mg KOH/g,

Polyol C-590, C1090, C-2090 and C-3090 sold by Kuraray, with a number-average molecular weight (Mₙ) ranging from 500 to 3000 g/mol and a hydroxyl number ranging from 224 to 37 mg KOH/g.

The polycaprolactone polyol(s), that can be used according to the invention, can have a number-average molecular weight (Mn) ranging from 240 to 10000 g/mol, and preferentially from 1000 to 6000 g/mol.

Examples of polycaprolactone polyol(s) that may be mentioned include the CAPA™ polyols sold by Perstorp, such as for example:

the CAPA™ diols: CAPA™ 2201 (Mn=2000 g/mol), CAPA™ 2303 (Mn=3000 g/mol);

the CAPA™ triols: CAPA™ 3201 (Mn=2000 g/mol), CAPA™ 3301 (Mn=3000 g/mol);

the CAPA™ tetrols: CAPA™ 4101 (Mn=1000 g/mol).

Among the poly(ether-ester) polyols, mention may for example be made of those described in WO 2013/110512, WO 2012/02048 or U.S. Pat. No. 7,893,189.

The poly(meth)acrylate polyol(s), that can be used according to the invention can have a number-average molecular weight (Mn) ranging from 1000 to 22000 g/mol, preferably from 1000 to 10000 g/mol, and even more preferentially from 1000 to 6000 g/mol.

The poly(meth)acrylate polyol(s) that can be used according to the invention is (are) preferably chosen from homopolymers, copolymers and terpolymers of acrylate and/or methacrylate monomer(s).

More preferentially, the poly(meth)acrylate polyol(s) that can be used according to the invention is (are) preferably chosen from poly(meth)acrylate diols and poly(meth)acrylate triols (telechelic).

Examples of poly(meth)acrylate polyol(s) that may be mentioned include Tego® Diol MD-1000, BD-1000, BD-2000 and OD-2000 sold by Evonik Tego Chemie.

According to one preferred embodiment, step E″1) is performed in the presence of at least one polyether polyol, preferentially at least one polyether diol.

Polyisocyanate(s)

The polyisocyanate(s) that can be used according to the invention in steps E1) or E′1) and E″1) may be added sequentially or reacted in the form of a mixture.

According to one embodiment, the polyisocyanate(s) that can be used are diisocyanate(s), preferably chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (especially m-xylylene diisocyanate (m-XDI)), toluene diisocyanate (especially 2,4-toluene diisocyanate (2,4-TDI) and/or 2,6-toluene diisocyanate (2,6-TDI)), diphenylmethane diisocyanate (especially 4,4′-diphenylmethane diisocyanate (4,4′-MDI) and/or 2,4′-diphenylmethane diisocyanate (2,4′-MDI)), tetramethylxylylene diisocyanate (TMXDI) (especially tetramethyl-meta-xylylene diisocyanate), an HDI allophanate, for example having the following formula (Y):

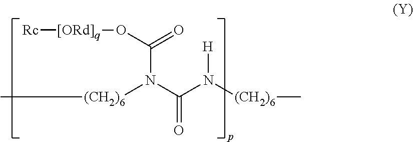

wherein p is an integer ranging from 1 to 2, q is an integer ranging from 0 to 9 and preferably from 2 to 5, Rc represents a saturated or unsaturated, cyclic or acyclic, linear or branched, hydrocarbon-based chain comprising from 1 to 20 carbon atoms, preferably from 6 to 14 carbon atoms, and Rd represents a linear or branched divalent alkylene group having from 2 to 4 carbon atoms, and preferably a divalent propylene group;
and mixtures thereof.

Preferably, the allophanate of abovementioned formula (Y) is such that p, q, Rc and Rd are chosen such that the above HDI allophanate derivative comprises a content of isocyanate NCO groups ranging from 12% to 14% by weight, relative to the weight of said derivative.

According to one embodiment, the polyisocyanate(s) that may be used are triisocyanate(s), preferably chosen from isocyanurates, biurets and adducts of diisocyanates and of triols.

In particular, the isocyanurate(s) may be used in the form of a technical mixture of (poly)isocyanurate(s) with a purity of greater than or equal to 70% by weight of isocyanurate(s).

Preferably, the diisocyanate isocyanurate(s) that may be used according to the invention correspond(s) to the general formula (W) below:

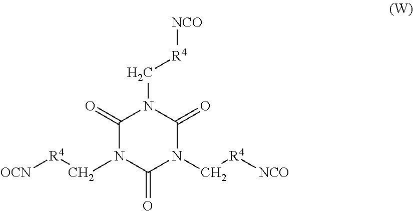

wherein:

R⁴ represents a linear or branched, cyclic, aliphatic, arylaliphatic or aromatic alkylene group comprising from 4 to 9 carbon atoms,

with the proviso that the NCO groups are not connected by a covalent bond to a carbon atom forming part of an aromatic hydrocarbon-based ring, such as a phenyl group.

As examples of diisocyanate trimers that may be used according to the invention, mention may be made of:

the isocyanurate trimer of hexamethylene diisocyanate (HDI):

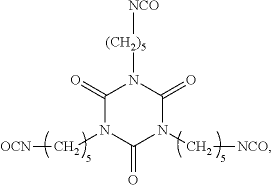

the isocyanurate trimer of isophorone diisocyanate (IPDI):

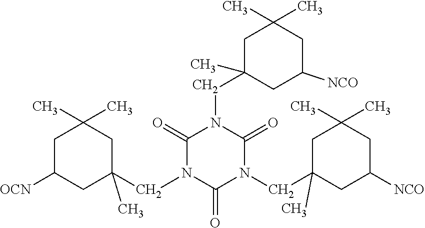

the isocyanurate trimer of pentamethylene diisocyanate (PDI):

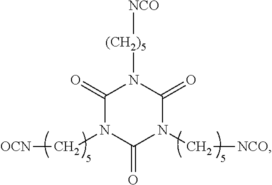

the isocyanurate trimer of meta-xylylene diisocyanate (m-XDI):

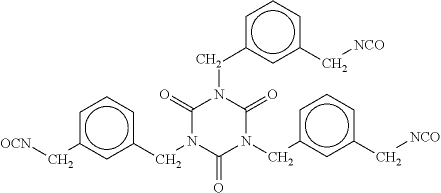

the isocyanurate trimer of m-XDI, in the hydrogenated form:

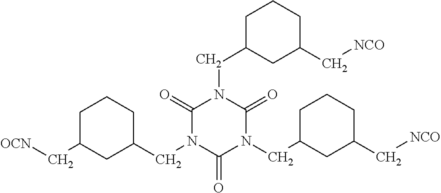

As examples of adducts of diisocyanates and of triols that may be used according to the invention, mention may be made of the adduct of meta-xylylene diisocyanate and of trimethylolpropane, as represented below. This adduct is sold, for example, by Mitsui Chemicals, Inc. under the name Takenate® D-110N.

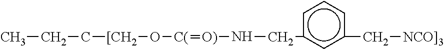

The polyisocyanate(s) that may be used to prepare the polyurethane used according to the invention are widely commercially available. By way of example, mention may be made of Scuranate® TX sold by Vencorex, corresponding to a 2,4-TDI having a purity of the order of 95%, Scuranate® T100 sold by Vencorex, corresponding to a 2,4-TDI having a purity of greater than 99% by weight, Desmodur® I sold by Covestro, corresponding to an IPDI or Desmodur® N3300 sold by Covestro, corresponding to an HDI isocyanurate, Takenate™ 500 sold by Mitsui Chemicals, corresponding to an m-XDI, Takenate™ 600 sold by Mitsui Chemicals, corresponding to an m-H6XDI, Vestanat® H12MDI sold by Evonik, corresponding to an H12MDI.

Preferably, the polyisocyanate(s) is (are) chosen from toluene diisocyanate (in particular the isomer 2,4-TDI, the isomer 2,6-TDI or mixtures thereof), meta-xylylene, HDI isocyanurate, and mixtures thereof. In particular, the polyisocyanate is toluene diisocyanate.

Reaction Conditions

The polyaddition reaction of step E1), E′1) or E″1) may be performed at a temperature below 95° C. and/or under anhydrous conditions.

The polyaddition reaction of step E1), E′1) or E″1) may be performed in the presence or absence of at least one reaction catalyst.

The reaction catalyst(s) that can be used during the polyaddition reaction of step E1), E′1) or E″1) can be any catalyst known to those skilled in the art for catalyzing the formation of polyurethane by reaction of at least one polyisocyanate with at least one polyol.

An amount ranging up to 0.3% by weight of catalyst(s), relative to the weight of the reaction medium of step E1), E′1) or E″1), can be used. In particular, it is preferred to use from 0.02% to 0.2% by weight of catalyst(s) relative to the weight of the reaction medium of step E1), E′1) or E″1).

Steps E2). E′2) and E″2)

In the presence of acrylic acid ester, the transesterification reaction of step E2) may be performed at a temperature above 110° C., preferably above 120° C.

Among the acrylic acid esters, examples that may be mentioned include methyl acrylate, butyl acrylate, propyl acrylate and pentyl acrylate.

In the presence of acrylic acid chloride, the reaction of step E2) may be performed at a temperature preferably below 95° C., under preferably anhydrous conditions.

In the presence of isocyanatoalkyl acrylate, the reaction of step E′2) may be performed at a temperature preferably below 95° C., preferably under anhydrous conditions.

In the presence of hydroxylated ester(s) of acrylic acid, or of hydroxylated amide(s) of acrylic acid, the reaction of step E″2) may be performed at a temperature preferably below 95° C., under preferably anhydrous conditions.

The hydroxylated esters of acrylic acid may be used either pure or in the form of a mixture of different hydroxylated esters of acrylic acid with a mean hydroxyl number of said mixture ranging from 8 to 483 mg KOH/g of said mixture.

### Additional Ingredients

According to one preferred embodiment, the composition A does not comprise any multifunctional polyol (meth)acrylate ester. According to the invention, the multifunctional polyol (meth)acrylate ester is a polyol comprising at least two OH functions in the form of an ester of acrylic acid or of methacrylic acid.

The multifunctional polyol (meth)acrylate ester can comprise non-esterified OH functions.

It may for example be the esters defined in U.S. Pat. No. 4,051,195.

The multifunctional polyol (meth)acrylate esters can be obtained from diols or triols which are optionally ethoxylated and/or propoxylated.

Mention may for example be made of 1,3-propanediol diacrylate, esterdiol diacrylate (EDDA-CAS number: 30145-51-8), 1,6-hexanediol diacrylate (HDDA), dipropylene glycol diacrylate (DPGDA), tripropylene glycol diacrylate (TPGDA), 3-methyl-1,5-pentadiol diacrylate (MPDA), trimethylolpropane triacrylate (TMPTA), pentaerythritol tetraacrylate (PETTA), di-trimethylolpropane tetraacrylate (DiTMPTTA), neopentyl glycol propoxylate diacrylate (CAS number: 84170-74-1), and mixtures thereof.

The composition A may optionally comprise at least one aliphatic urethane-acrylate oligomer.

It may for example be CN925® (tetrafunctional aliphatic urethane-acrylate having an Mn of approximately 2500 g/mol) or CN 9245S® (trifunctional aliphatic urethane-acrylate having an Mn of approximately 5000 g/mol) sold by Sartomer.

The composition A can have a viscosity, measured at ambient temperature (23° C.), ranging from 100 to 250000 mPa·s, preferably ranging from 10000 to 80000 mPa·s.

Preferably, the weight ratio of polyurethane(s) P/epoxy resin(s) in the composition A ranges from 55/45 to 95/5, preferentially from 60/40 to 90/10, advantageously from 65/35 to 85/25, and for example the ratio is 70/30.

A.2. Composition B

The composition B according to the invention comprises:
at least one polyamine B1 comprising at least two functions chosen from primary and secondary amines;
at least one polyamine B2, different than the polyamine B1, comprising at least two functions chosen from primary and secondary amines.

Polyamine B1

Preferably, the polyamine B1 comprises at least two primary amine functions —NH₂.

The polyamine B1 can have a primary alkalinity of greater than or equal to 7 meq/g, preferably greater than or equal to 10 meq/g, preferentially greater than or equal to 13 meq/g.

According to one embodiment, polyamine B1 has formula (V) below:

NH₂CH₂—Z—CH₂—NH₂ (V)

wherein Z represents a linear or branched, cyclic, aliphatic or aromatic, saturated or unsaturated divalent hydrocarbon-based radical, preferably comprising from 1 to 22 carbon atoms, said hydrocarbon-based radical being optionally interrupted with one or more heteroatoms chosen from —S—, —O— and/or one or more divalent tertiary amine groups —NR′″— with R′″ representing a linear or branched, saturated or unsaturated alkyl group, comprising 1 to 22 carbon atoms, preferably from 1 to 18, preferably from 1 to 14, preferentially from 1 to 10 and advantageously from 1 to 6 carbon atoms.

Preferably, polyamine B1 corresponds to one of the formulae (V-1), (V-2) or (V3) below:

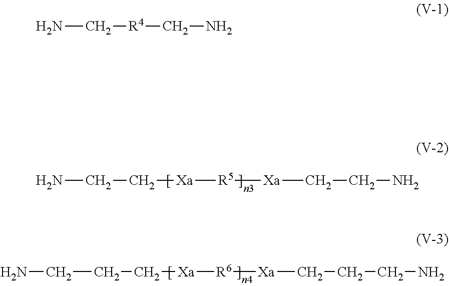

wherein:

R⁴ is a linear or branched divalent alkylene radical, or a divalent arylene radical, comprising from 1 to 18 carbon atoms, R⁴ preferably representing a linear alkylene radical comprising 6, 10 or 12 carbon atoms;

R⁵ represents a linear or branched divalent alkylene radical comprising from 2 to 12 carbon atoms, preferentially ethylene or propylene,

R⁶ represents a linear or branched divalent alkylene radical comprising from 2 to 10 carbon atoms, preferentially ethylene or propylene,

Xₐ═O, S, NR⁷ wherein R⁷ represents H or a saturated or unsaturated, linear or branched alkyl group comprising from 1 to 10 carbon atoms, preferentially from 1 to 4 carbon atoms, X preferably representing 0;

n₃ is an integer ranging from 0 to 4 and advantageously being equal to 1 or 2;

n₄ is an integer ranging from 0 to 2 and advantageously being equal to 1.

Polyamine B1 is preferably a polyamine of formula (V-2) above, wherein Xₐ preferably represents 0, and n₃ is preferably 1.

Preferably, polyamine B1 is chosen from diethylenetriamine (DETA): H₂N—CH₂—CH₂—NH—CH₂—CH₂—NH₂, 1,10-decanediamine: H₂N—(CH₂)₁₀—NH₂, 1,12-dodecanediamine: H₂N—(CH₂)₁₂-NH₂, 1,6-hexamethylenediamine (HMDA), the polyetherdiamines of formulae H₂N—CH₂—CH₂—O—CH₂—CH₂—O—CH₂—CH₂—NH₂ and H₂N—CH₂—CH₂—CH₂—O—CH₂—CH₂—O—CH₂—CH₂—CH₂—NH₂ (available, for example, under the respective trade names Jeffamine® EDR 148 and Jeffamine® EDR 176 from Huntsman).

Polyamine B2

Preferably, the polyamine B2 comprises at least two, preferably at least three, primary amine functions —NH₂.

The polyamine B2 or the mixture of polyamines B2 may have a primary alkalinity strictly less than 10.00 meq/g, preferably between 3.0 and less than 10.00 meq/g.

According to one embodiment, polyamine B2 is chosen from the group consisting of polyetheramines, polyamidoamines, fatty amine dimers or trimers, polyethyleneimines (PEI), polyethyleneimine dendrimers, polypropyleneimines (PPI), polypropyleneimine dendrimers, polyallylamines, poly(propylene-ethylene)imines, and mixtures thereof, said polyamine preferably having a primary alkalinity strictly less than 10.00 meq/g, preferably between 3.0 and less than 10.00 meq/g.

According to one embodiment, polyamine B2 is chosen from polyetheramines, in particular chosen from:
polyetherdiamines, such as, for example:
   polyetherdiamines corresponding to the formula below:

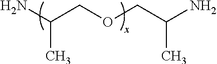

wherein x is an integer such that the primary alkalinity of the polyetherdiamine is between 0.5 and less than 10 meq/g, x preferably ranging from 2 to 68 (such polyetherdiamines are sold, for example, under the name Jeffamines D-230, D-400, D-2000 and D-4000 by Huntsman and have respective primary alkalinities of 8.7, 5.0, 1.0 and 0.5 meq/g);
   polyetherdiamines corresponding to the formula below:

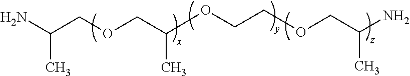

wherein x, y and z are integers such that the primary alkalinity is between 1 and less than 10 meq/g, y preferably ranging from 2 to 39 and x+z ranging from 1 to 6 (such polyetherdiamines are sold, for example, under the name Jeffamines HK-511, ED-600, ED-900 and ED-2003 by Huntsman and have respective primary alkalinities of 9.1, 3.3, 2.2 and 1.0 meq/g);
   polyetherdiamines corresponding to the following formula:

H₂N—X_{b}(—O—X_{b})ₘ₋₁—O—(CH₂—CH₂—CH₂—CH₂—O)ₙ—(X_{b}—O)ₘ₋₁—X_{b}—NH₂
wherein X_{b} is a linear or branched alkylene group preferably comprising from 2 to 20 carbon atoms, preferably from 2 to 10 carbon atoms, m is an integer ranging from 1 to 20 and n is an integer ranging from 1 to 100, m and n preferably being such that the primary alkalinity of the polyetherdiamines is strictly less than 10 meq/g;
polyethertriamines, for instance those corresponding corresponding to the formula below:

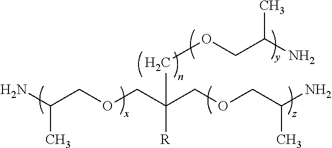

wherein R is a hydrogen atom or a C1 to C2 alkyl group, x, y, z and n are integers such that the primary alkalinity of the polyethertriamine is between 0.5 and less than 10 meq/g, n preferably ranging from 0 to 1 and x+y+z ranging from 5 to 85 (such polyethertriamines are sold, for example, under the name Jeffamines T-403, T-3000, and T-5000 by Huntsman and have respective primary alkalinities of 6.8, 1.0 and 0.6 meq/g).

According to another embodiment, polyamine B2 is chosen from fatty amine dimers and trimers including two or three primary amine groups with a primary alkalinity ranging from 3.28 meq/g to 5.20 meq/g. These fatty amine dimers and trimers can be obtained from corresponding dimerized and trimerized fatty acids. Mention may be made, as examples of such partially or completely hydrogenated fatty amine dimers, of those corresponding to the following formulae:

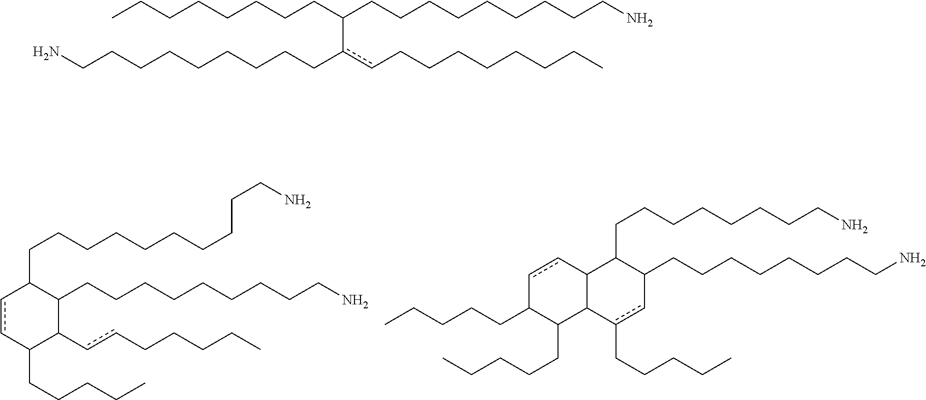

The fatty acid dimers and trimers used to prepare the abovementioned fatty amines may be obtained by high-temperature polymerization under pressure of unsaturated monocarboxylic fatty acids (monomeric acid) comprising from 6 to 22 carbon atoms, preferably from 12 to 20 carbon atoms, and originate from plant or animal sources. Mention may be made, as examples of such unsaturated fatty acids, of C₁₈ acids having one or two double bonds (respectively oleic acid or linoleic acid) obtained from tall oil, which is a byproduct of the manufacture of paper pulp. After polymerization of these unsaturated fatty acids, a technical mixture is notably obtained which contains, on average, 30-35% by weight of monocarboxylic fatty acids, often isomerized, relative to the starting unsaturated monocarboxylic fatty acids, 60-65% by weight of dicarboxylic acids (dimeric acids) comprising twice the carbon number relative to the starting unsaturated monocarboxylic fatty acids, and 5-10% by weight of tricarboxylic acids (trimeric acids) containing three times the carbon number relative to the starting unsaturated monocarboxylic fatty acids. The different commercial grades of acid dimers, monomers or trimers are obtained in particular by purification of this mixture. These fatty acid dimers and trimers are subsequently typically subjected to a reductive ammoniation (NH₃/H₂) reaction in the presence of a catalyst, making it possible to obtain the dimerized fatty amines.

According to another embodiment, polyamine B2 is chosen from polyethyleneimines (PEI) preferably with a number-average molecular weight (Mn) ranging from 450 to 25000 g/mol and a primary alkalinity/total alkalinity ratio ranging from 0.35 to 0.45, and in particular containing at least one radical having the following formula:

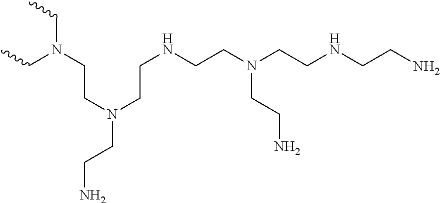

Mention may for example be made of the polyethyleneimines sold under the name Lupasol sold by BASF, such as Lupasol FG with an Mn exhibiting a molar mass of 800 g/mol, a primary alkalinity of 10.00 meq/g and a total alkalinity of 24.00 meq/g, a sum of the primary alkalinity and the secondary alkalinity which is 19 meq/g, a primary alkalinity/total alkalinity ratio of 0.42, and a secondary alkalinity/total alkalinity of 0.38, determined by ¹³C NMR.

Preferably, the polyamine B2 is chosen from polyetheramines, polyethyleneimines (PEI) as defined above, and mixtures thereof.

According to one embodiment, the composition B has a primary alkalinity/total alkalinity ratio ranging from 0.25 to 1.00.

The polyamine(s) B1/polyamine(s) B2 weight ratio in composition B may range from 90/10 to 10/90, preferably from 80/20 to 20/80, preferentially from 30/70 to 70/30, even more preferentially from 60/40 to 40/60 and even better still is approximately 50/50. The composition B may be prepared by simple mixing of the constituents, preferably at a temperature ranging from 10° C. to 50° C., preferably at ambient temperature, preferably using a mechanical mixer with or without addition of solvent.

A.3. Composition

The composition A and/or B may comprise at least one additive chosen from the group consisting of fillers, catalysts, dyes, adhesion promoters, thixotropic agents, solvents, and mixtures thereof.

The composition A and/or B may also comprise at least one solvent, preferably in an amount ranging from 10% to 50% by weight, more preferentially ranging from 15% to 40% by weight and better still ranging from 20% to 30% by weight, relative to the total weight of composition A (or B).

The solvent may be chosen from organic solvents and alcoholic solvents such as ethyl acetate, methyl ethyl ketone, xylene, ethanol, isopropanol, tetrahydrofuran, methyltetrahydrofuran or else from Isane® (based on isoparaffins, available from Total) or Exxol® D80 (based on aliphatic hydrocarbons, available from ExxonMobil Chemical).

The catalyst(s) may be any catalyst usually used to accelerate the reaction for addition of a compound comprising a primary or secondary amine to a compound comprising an acrylate group.

According to one embodiment, the catalyst is chosen from the group consisting of Lewis bases and Brønsted bases, the conjugate acids of which have a pKa≤10, hydroxides (for instance LiOH, NaOH or KOH), hydrides (for instance NaH, KH or CaH₂), carbonates (for instance CaCO₃, Na₂CO₃ or K₂CO₃), alkali metal alkoxides (for instance sodium methoxide, potassium methoxide, sodium ethoxide, potassium tert-butoxide, titanium tetraisopropoxide), and mixtures thereof.

The Lewis bases and Brønsted bases of which the conjugate acids have a pKa≥10 may typically be those described in Houben-Weyl, vol. XI/1, (1957), page 277 ff. and in Patai, “The Chemistry of the Amino Group”, pages 61-65, Interscience, New York (1968).

Preferably, the Lewis bases are chosen from the group consisting of cycloaliphatic amines, such as 1,4-diazabicyclo[2.2.2]octane (DABCO) or 2,2′-dimorpholinodiethyl ether (DMDEE); aliphatic tertiary amines, for instance triethylamine, tripropylamine, tributylamine, N-methyldiethanolamine, N-methyldiisopropylamine or N-butyldiethanolamine; amidines, for instance 1,5-diazabicyclo[4.3.0]non-5-ene (DBN), 1,8-diazabicyclo[5.4.0]undec-7-ene (DBU); guanidines, for instance N,N,N′,N′-tetramethylguanidine, 1,5,7-triazabicyclo[4.4.0]dec-5-ene (TBD) or N-methyl triazabicyclodecene (Me-TBD); copolymers of 2,3,4-vinylpyridine or of amine acrylates such as 2-dimethylaminoethyl acrylate, 2-diethylaminoethyl acrylate or 3-dimethylaminopropyl acrylate; phosphazenes, for instance 2-tert-butylimino-2-diethylamino-1,3-dimethylperhydro-1,3,2-diazaphosphoride (BMEP); alkyl or aryl alkyl phosphanes, for instance tributylphosphane, triphenylphosphane, tris-p-tolylphosphane, methyldiphenylphosphane; hydroxy and amino phosphanes; basic ion-exchange resins; and mixtures thereof.

Among the Lewis bases that are particularly preferred according to the invention, mention may be made of:

guanidines, for instance:

### 1,5,7-triazabicyclo[4.4.0]dec-5-ene (TBD)

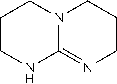

### N-methyltriazabicyclodecene (Me-TBD)

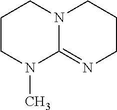

amidines, for instance:

### 1,8-diazabicyclo[5.4.0]undec-7-ene (DBU)

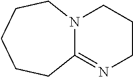 [SMILES: C1CCC2=NCCCN2CC1]

### 1,5-diazabicyclo[4.3.0]non-5-ene (DBN)

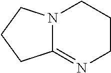

tertiary amines, for instance:

### 2,2′-dimorpholinodiethyl ether (DMDEE)

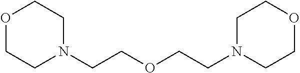 [SMILES: C1CN(CCOCCN2CCOCC2)CCO1]

### 1,4-diazabicyclo[2.2.2]octane (DABCO)

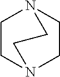

An amount ranging from 0.05% to 5% by weight, preferentially from 0.1% to 3% by weight of catalyst(s) relative to the total weight of the composition according to the invention may be added.

The composition according to the invention may also comprise at least one organic and/or mineral filler. The filler(s) may be present in the composition A and/or in the composition B.

The mineral filler(s) that may be used is (are) advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically in the form of particles of diverse geometry. They may be, for example, spherical or fibrous or may have an irregular shape.

Preferably, the filler(s) is (are) chosen from the group consisting of clay, quartz, carbonate fillers, kaolin, gypsum, clays and mixtures thereof; preferentially, the filler(s) is (are) chosen from carbonate fillers, such as alkali metal or alkaline-earth metal carbonates, and more preferentially calcium carbonate or chalk.

These fillers may be untreated or treated, for example using an organic acid, such as stearic acid, or a mixture of organic acids predominantly consisting of stearic acid.

Use may also be made of hollow mineral microspheres, such as hollow glass microspheres, and more particularly those made of calcium sodium borosilicate or of aluminosilicate.

The composition according to the invention may also comprise at least one adhesion promoter preferably chosen from silanes, such as aminosilanes, epoxysilanes or acryloylsilanes. The adhesion promoter(s) is (are) preferably present in the composition A.

Preferably, the composition according to the invention is such that the mole ratio (r5) as defined below ranges from 0.5 to 2, preferably from 0.7 to 1.3, preferentially from 0.8 to 1.2:

$$( r 7 ) = \frac{x}{y}$$

with:

x representing the sum of the number of primary amine functions (NH₂) and of the number of secondary amine functions (expressed in meq per gram of the mixture of polyamines B1 and B2) present in the reagents of the composition B;

y representing the sum of the number of epoxy functions (expressed in meq per gram of epoxy resin(s)) and of acrylate functions (expressed in meq per gram of polyurethane(s) P) present in the reagents of the composition A.

### B. Ready-to-Use Kit

The present invention also relates to a ready-to-use kit, comprising composition A as defined above, on the one hand, and composition B as defined above, on the other hand, packaged in two separate compartments.

Specifically, the composition according to the invention may be in a two-component form, for example in a ready-to-use kit, comprising composition A, on the one hand, in a first compartment or drum and composition B, on the other hand, in a second compartment or drum, in proportions suitable for direct mixing of the two compositions, for example by means of a metering pump.

According to one embodiment of the invention, the kit also comprises one or more means for mixing the two compositions A and B. Preferably, the mixing means are chosen from metering pumps and static mixers of diameter suited to the amounts used.

### C. Uses

The present invention also relates to the use of a composition as defined above as adhesive, sealant or coating, preferably as adhesive.

The invention also relates to the use of said composition in the repair and/or the structural or semi-structural adhesive bonding of materials in the transportation, motor vehicle (car, bus or truck), marine or construction field.

The present invention also relates to a method for assembling two substrates by adhesive bonding, comprising:
coating, onto at least one of the two substrates to be assembled, a composition obtained by mixing the compositions A and B as defined above; then
actually bringing the two substrates into contact.

The appropriate substrates are, for example, inorganic substrates, such as concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters, epoxy resins; substrates made of metal and composites coated with paint.

The composition according to the invention advantageously results in an adhesive seal having:

a tensile strength of greater than or equal to 3 MPa, preferably of between 3 and 15 MPa, advantageously between 3 and 10 MPa, and in particular between 5 and 8 MPa; and/or

an elongation at break of greater than or equal to 20%, preferably ranging from 20% to 200%, preferentially from 25% to 150%, and in particular between 40% and 90%.

The invention also relates to the use of said composition in the repair and/or the semi-structural or structural adhesive bonding of materials in the transportation, marine or construction field.

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range wherein the limits x and y are included. For example, the range “between 0% and 25%” notably includes the values 0% and 25%.

The invention is now described in the following exemplary embodiments, which are given purely by way of illustration and should not be interpreted in order to limit the scope thereof.

### Experimental Section

The following ingredients were used:
Voranol™ P2000 available from Dow is a polypropylene glycol (PPG) of functionality F=2 having an OHN of 55 mg KOH/g, i.e. a number-average molecular weight (Mn) in the region of 2040 g/mol;
Borchi® KAT 315 available from Borchers is a bismuth neodecanoate used as tin-free catalyst;
Scuranate® TX available from Vencorex is a toluene diisocyanate (TDI) containing 48.1% by weight of NCO functions and comprising 95% by weight of 2,4-TDI isomer;
2-hydroxyethyl acrylate (HEA) available from BASF has a purity of 98.5% by weight and contains 250±50 ppm of HQME;
Jeffamine® EDR-148 (available from Huntsman) is a diamine (of B1 type) corresponding to the formula H₂N—CH₂—CH₂—O—CH₂—CH₂—O—CH₂—CH₂—NH₂, having a molar mass of 148 g/mol, a primary and total alkalinity of 13.50 meq/g and a primary alkalinity/total alkalinity ratio of 1.00 determined by potentiometry;
Lupasol® FG (available from BASF) is a polyamine (of B2 type) of polyethyleneimine (PEI) type with a molar mass of 800 g/mol, a primary alkalinity of 10.00 meq/g and a total alkalinity of 24.00 meq/g, a sum of the primary alkalinity and of the secondary alkalinity of 19 meq/g, a primary alkalinity/total alkalinity ratio of 0.42 and a secondary alkalinity/total alkalinity ratio of 0.38 determined by ¹³C NMR, i.e. a ratio of the sum of the primary alkalinity and of the secondary alkalinity/total alkalinity of 0.79;
D.E.R.™ 331 available from Dow Chemicals is a liquid BADGE resin obtained by reaction between bisphenol A and epichlorohydrin, and having an epoxy function content ranging from 5.2 to 5.5 meq/g.

### Example 1: Preparation of a Polvether Polvol-Based Polyurethane

15.6 g of Scuranate® TX are introduced into a reactor and heated to 40° C. 72.0 g of Voranol® P2000 are then introduced while making sure that the temperature of the mixture does not exceed 80° C. When the temperature of the mixture has stabilized, the mixture is heated for approximately 1 hour at 80-85° C.

The end of the reaction is monitored by controlling the weight percentage of NCO functions in the medium, this percentage needing to be in theory approximately . . . % by weight. When the reaction is complete, the mixture is cooled to 70° C. and 12.4 g of 2-hydroxyethyl acrylate and 0.01 g of Borchi Kat® 315 are introduced. The mixture is maintained at 70° C. for 6 to 8 hours until no more NCO functions are visible on infrared (IR) (disappearance of the characteristic band of the NCO function at about 2250 cm⁻¹).

The polyurethane obtained has a viscosity, measured at 23° C., of 59600 mPa·s.

### Example 2: Preparation of a Composition A

The composition A was prepared by mixing, at ambient temperature (23° C.), the polyurethane obtained in example 1 with the D.E.R. 331 resin in a 70/30 (polyurethane/epoxy resin) weight ratio.

### Example 3: Preparation of the Compositions B

The compositions B that were tested were prepared by simple mixing of the polyamine(s) B1 and/or of the polyamine(s) B2 at ambient temperature (approximately 23° C.) in a B1/B2 weight ratio indicated below in table 1.

### Example 4: Preparation of the Adhesive Compositions

The mixture of the compositions A and B detailed in examples 2 and 3 was prepared in an A/B weight ratio indicated below in table 1.

TABLE 1

| | | | B1/B2 | |
|---|---|---|---|---|
| | | | weight | A/B |
| | Nature of A | Composition of B | ratio | ratio |
| Composition 1 | example 2 | Jeffamine ® EDR-148 | 1/1 | 100/9.9 |
| | | (B1)/Lupasol ® | | |
| | | FG (B2) | | |
| Composition 2 | example 2 | Jeffamine ® EDR-148 | 8/2 | 100/9.2 |
| | | (B1)/Lupasol ® | | |
| | | FG (B2) | | |

### Example 5: Evaluation of the Performance Qualities

Measurement of the Tensile Strength and of the Elongation at Break by a Tensile Test:

The measurement of the tensile strength (breaking stress) and of the elongation at break by a tensile test was carried out according to the protocol described below.

The principle of the measurement consists in drawing, in a tensile testing device, the movable jaw of which moves at a constant rate equal to 100 mm/minute, a standard test specimen consisting of the crosslinked composition and in recording, at the moment when the test specimen breaks, the tensile stress applied (in MPa) and also the elongation of the test specimen (in %). The standard test specimen is dumbbell-shaped, as illustrated in the international standard ISO 37 of 2011. The narrow part of the dumbbell used has a length of 20 mm, a width of 4 mm and a thickness of 500 μm.

### Adhesive Bonding Tests

The adhesive bondings are produced on strips made of beech or of sheet metal which is painted originating from Rocholl. An area of 25×12.5 mm was delimited on a strip by means of Teflon blocks 1 mm thick and area of 25×12.5 mm. This area was filled with the composition to be tested, then a second strip of the same material was laminated. The combination was held by a clamp and placed in a climate-controlled chamber at 23° C. and 50% RH (relative humidity) for a week before tensile testing on a universal testing machine. The aim of the tensile testing on a universal testing machine is to evaluate the maximum force (in MPa) to be exerted on the assemblage in order to separate it. Recourse to a tensile testing device makes it possible to subject a lap joint placed between two rigid supports to a shear stress up to failure by exerting tension on the supports parallel to the surface of the assemblage and to the main axis of the test specimen. The result to be recorded is the breaking force or stress. The shear stress is applied via the movable jaw of the tensile testing device with a displacement at the rate of 100 mm/min. This tensile testing method is carried out as defined by the standard EN 1465 of 2009.

The properties obtained for the compositions prepared are summarized in the table below:

Test specimen H2

| | Elongation at | Tensile strength |
|---|---|---|
| Composition | break (%) | (MPa) |
| Composition 1 | 36 | 7.8 |
| Composition 2 | 80 | 7.6 |

1-18. (canceled)

19. An adhesive composition comprising:
a composition A comprising:
at least one polyurethane P comprising at least two acrylate end functions; and
at least one epoxy resin; and
a composition B comprising:
at least one polyamine B1 comprising at least two functions chosen from primary and secondary amines;
at least one polyamine B2, different than the polyamine B1, comprising at least two functions chosen from primary and secondary amines;
wherein:
the adhesive composition does not comprise any polythiol; and
the weight ratio of polyurethane(s) P/epoxy resin(s) in composition A ranges from 51/49 to 99/1.

20. The composition as claimed in claim 19, wherein the epoxy resin has a viscosity, measured at 23° C., of from 7 to 13000 mPa·s.

21. The composition as claimed in claim 19, wherein the epoxy resins are chosen from the following resins:
the resins having formula (I) below: 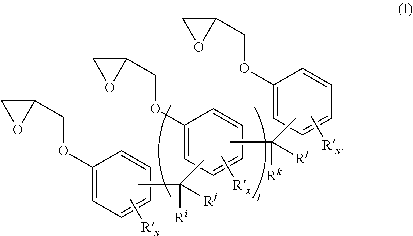
wherein:
I represents a number ranging from 0 to 8;
each R′ represents, independently of one another, an alkyl radical comprising from 1 to 20 carbon atoms;
each of Rⁱ, R^{j}, R^{k} and R^{l}, independently of one another, represents one of the following radicals: H; a linear or branched, cyclic or aliphatic alkyl radical comprising from 1 to 10 carbon atoms; an aryl radical comprising from 6 to 12 carbon atoms; or a radical —CF₃;
each x represents an integer ranging from 0 to 4;
N,N-diglycidyl-4-glycidyloxyaniline (TGAP); 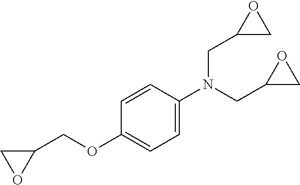 [SMILES: c1cc(N(CC2CO2)CC2CO2)ccc1OCC1CO1]
4,4′-methylenebis(N,N-diglycidylaniline) (TGDDM); 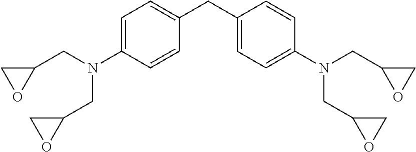 [SMILES: c1cc(N(CC2CO2)CC2CO2)ccc1Cc1ccc(N(CC2CO2)CC2CO2)cc1]
the resins of formula (II) below: 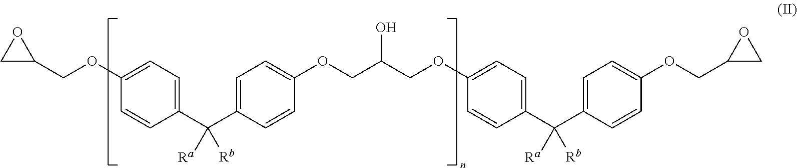
wherein:
n is an integer ranging from 1 to 25;
each of R^{a} and R^{b} is, independently of one another, one of the following radicals: H; a linear or branched, cyclic or aliphatic alkyl radical comprising from 1 to 10 carbon atoms; an aryl radical comprising from 6 to 12 carbon atoms; or a radical —CF₃;
and mixtures thereof.

22. The composition as claimed in claim 19, wherein the polyurethane P has an acrylate function content ranging from 0.2 to 3 meq per gram of polyurethane P.

23. The composition as claimed in claim 19, wherein the acrylate functionality of the polyurethane P ranges from 1 to 4.

24. The composition as claimed in claim 19, wherein the polyurethane P is obtained by reaction:
i. of a polyurethane comprising at least two —OH end functions and of at least one compound chosen from acrylic acid chloride or an acrylic acid ester; or
ii. of a polyurethane comprising at least two —OH end functions and of at least one compound chosen from an isocyanatoalkyl acrylate; or
iii. of a polyurethane comprising at least two —NCO end functions and of at least one compound chosen from a hydroxylated ester of acrylic acid.

25. The composition as claimed in claim 24, wherein the hydroxylated ester of acrylic acid has one of formulae (IV-1-1) and (IV-1-2) below:
CH₂═CH—C(═O)—O—CH₂—CH₂—OH (IV-1-1): 2-hydroxyethyl acrylate (HEA):
CH₂═CH—C(═O)—O—CH₂—CH(Me)-OH (IV-1-2): 2-hydroxypropyl acrylate (HPA):

26. The composition as claimed in claim 19, wherein the polyurethane P is prepared via a process comprising the following steps:
E″1) the preparation of a polyurethane bearing NCO end groups via a polyaddition reaction:
i) of at least one polyisocyanate;
ii) with at least one polyol;
in amounts such that the NCO/OH mole ratio (r5) is strictly greater than 1; and
E″2) the reaction of the product formed on conclusion of step E1) with at least one hydroxylated ester of acrylic acid as defined above, in amounts such that the OH/NCO mole ratio (r6) is less than or equal to 1.

27. The composition as claimed in claim 19, wherein the weight ratio of polyurethane(s) P/epoxy resin(s) in the composition A ranges from 55/45 to 95/5.

28. The composition as claimed in claim 19, wherein the composition A and/or the composition B comprises at least one additive selected from the group consisting of fillers, catalysts, dyes, adhesion promoters, thixotropic agents, solvents, and mixtures thereof.

29. The composition as claimed in claim 19, wherein the mole ratio (r5) ranges from 0.5 to 2:
$$( r 7 ) = \frac{x}{y}$$
with:
x representing the sum of the number of primary amine functions (NH₂) and of the number of secondary amine functions (in meq per gram of the mixture of polyamines B1 and B2) present in the reagents of the composition B; and
y representing the sum of the number of epoxy functions (expressed in meq per gram of epoxy resin(s)) and of the number of acrylate functions (expressed in meq per gram of polyurethane(s) P) present in the reagents of the composition A.

30. The composition as claimed in claim 19, wherein the polyamine B1 has a primary alkalinity of greater than or equal to 7 meq/g.

31. The composition as claimed in claim 19, wherein the polyamine B1 has formula (V) below:
NH₂—CH₂—Z—CH₂—NH₂ (V)
wherein Z represents a linear or branched, cyclic, aliphatic or aromatic, saturated or unsaturated divalent hydrocarbon-based radical, said hydrocarbon-based radical being optionally interrupted with one or more heteroatoms chosen from —S—, —O— and/or one or more divalent tertiary amine groups —NR′″— with R′″ representing a linear or branched, saturated or unsaturated alkyl group, comprising 1 to 22 carbon atoms.

32. The composition as claimed in claim 19, wherein polyamine B1 is selected from the group consisting of diethylenetriamine, 1,10-decanediamine, 1,12 dodecanediamine, 1,6-hexamethylenediamine, and polyetherdiamines of formulae H₂N—CH₂—CH₂—O—CH₂—CH₂—O—CH₂—CH₂—NH₂ and H₂N—CH₂—CH₂—CH₂—O—CH₂—CH₂—O—CH₂—CH₂—CH₂—NH₂.

33. The composition as claimed in claim 19, wherein the polyamine B2 or the mixture of polyamines B2 has a primary alkalinity strictly less than 10.00 meq/g.

34. The composition as claimed in claim 19, wherein the polyamine B2 is selected from the group consisting of polyetheramines, polyamidoamines, fatty amine dimers or trimers, polyethyleneimines (PEI), polyethyleneimine dendrimers, polypropyleneimines (PPI), polypropyleneimine dendrimers, polyallylamines, poly(propylene-ethylene)imines, and mixtures thereof.

35. The composition as claimed in claim 19, wherein it results in an adhesive seal having:
a tensile strength of greater than or equal to 3 MPa; and/or
an elongation at break of greater than or equal to 20%.

36. Method for assembling two substrates by adhesive bonding, comprising:
coating, onto at least one of the two substrates to be assembled, a composition obtained by mixing the compositions A and B as defined in claim 19; then
actually bringing the two substrates into contact.
